(19) United States
(12) Patent Application Publication
(10) Pub. No.: US 2005/0169371 A1
(43) Pub. Date: Aug. 4, 2005

(54) Video coding apparatus and method for inserting key frame adaptively

(75) Inventors: Jae-young Lee, Suwon-si (KR); Woo-jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/043,185

(22) Filed: Jan. 27, 2005

(30) Foreign Application Priority Data
Jan. 30, 2004 (KR) 10-2004-0006220

(51) Int. Cl. H04N 7/12

(52) U.S. Cl. 375/240.03; 375/240.23; 375/240.18; 348/700; 375/240.12

(57) ABSTRACT

A method of adaptively inserting a key frame according to video content to allow a user to easily access a desired scene. A video encoder includes a coding mode determination unit receiving a temporal residual frame with respect to an original frame, determining whether the original frame has a scene change by comparing the temporal residual frame with a predetermined reference, determining to encode the temporal residual frame when it is determined that the original frame does not have the scene change, and determining to encode the original frame when it is determined that the original frame has the scene change, and a spatial transformer performing spatial transform on either of the temporal residual frame and the original frame according to the determination of the coding mode determination unit and obtaining a transform coefficient. A keyframe is inserted according to access to a scene based on the content of an image, so that usability of a function allowing access to a random image frame is increased.

### CROSS-REFERENCE TO RELATED APPLICATION

This application claims priority from Korean Patent Application No. 10-2004-0006220 filed on Jan. 30, 2004 in the Korean Intellectual Property Office, the disclosure of which is incorporated herein by reference in its entirety.

### BACKGROUND OF THE INVENTION

1. Field of the Invention

The present invention relates to video compression, and more particularly, to a method of adaptively inserting a key frame according to video content to allow a user to easily access a desired scene.

2. Description of the Related Art

With the development of information communication technology including the Internet, video communication as well as text and voice communication has increased. Since conventional text communication cannot satisfy the various demands of users, multimedia services that can provide various types of information such as text, pictures, and music have increased. Multimedia data requires a large capacity storage medium and a wide bandwidth for transmission since the amount of multimedia data is usually large. For example, a 24-bit true color image having a resolution of 640*480 needs a capacity of 640*480*24 bits, i.e., data of about 7.37 Mbits, per frame. When this image is transmitted at a speed of 30 frames per second, a bandwidth of 221 Mbits/sec is required. When a 90-minute movie based on such an image is stored, a storage space of about 1200 Gbits is required. Accordingly, a compression coding method is a requisite for transmitting multimedia data including text, video, and audio.

A basic principle of data compression is removing data redundancy. Data can be compressed by removing spatial redundancy in which the same color or object is repeated in an image, temporal redundancy in which there is little change between adjacent frames in a moving image or the same sound is repeated in audio, or mental visual redundancy taking into account human eyesight and limited perception of high frequency. Data compression can be classified into lossy/lossless compression according to whether source data is lost, intraframe/interframe compression according to whether individual frames are compressed independently, and symmetric/asymmetric compression according to whether time required for compression is the same as time required for recovery. Data compression is defined as real-time compression when a compression/recovery time delay does not exceed 50 ms and as scalable compression when frames have different resolutions. For text or medical data, lossless compression is usually used. For multimedia data, lossy compression is usually used. Further, intraframe compression is usually used to remove spatial redundancy, and interframe compression is usually used to remove temporal redundancy.

Interframe compression, i.e., temporal compression typically uses a method of estimating a motion between consecutive frames in a time domain, performing motion compensation, and removing temporal redundancy using similarity between the frames. A block matching algorithm is widely used for the motion estimation. According to the block matching algorithm, displacement is obtained with respect to all pixels in a given block, and a value of a search point having least displacement is estimated as a motion vector. The motion estimation is divided into forward estimation in which a previous frame is referred to and backward estimation in which a subsequent frame is referred to. It will be noticed that a frame used as a reference frame in an encoder is not an encoded frame but an original frame corresponding to the encoded frame. However, instead of using this open-loop scheme, a closed-loop scheme may be used. That is, a decode frame may be used as a reference frame. Since the encoder fundamentally includes a function of a decoder, the decoded frame can be used as the reference frame.

In conventional video compression, three types of frames are present according to a method of setting the reference frame: an I intra-coded (I)-frame, a predictive coded (P)-frame, and a bi-directionally predictive coded (B)-frame. The I-frame indicates a frame that is spatially converted without using motion compensation. The P-frame is a frame on which forward or backward motion compensation is performed using an I-frame or another P-frame and the rest of which remaining after the motion compensation is spatially converted. The B-frame is a frame on which both of forward and backward motion compensations are performed using two other frames in the time domain.

Coding of a frame, such as an I-frame, that can be restored independently of another adjacent image frame is referred to as raw coding. Coding of a frame, such as P- or B-frame, that refers to a previous or succeeding I-frame or another adjacent P-frame to estimate a current image is referred to as differential image coding.

A keyframe is a single complete picture used for efficient image file compression. Frames are selected at regular intervals from a temporal image flow referring to a group-of-picture (GOP) structure and designated as keyframes. A keyframe can be restored independently and allows random access to images. Such keyframe indicates an I-frame that is inserted at regular intervals, as shown in FIG. 1, and can be reproduced independently in Moving Picture Experts Group (MPEG) standards, an H.261 standard, an H.264 standard, etc., but is not restricted thereto. Any frame that can be independently restored without referring to another frame regardless of video compression methods can be defined as a keyframe.

Since a conventional keyframe is usually inserted at regular intervals, image access at regular time intervals can be easily performed, but it is difficult to perform random access such as scene-changed image access. The scene-changed image access is accessing images, in which content (i.e., a plot) of images changes, such as images corresponding to scene transition, fade-in, and fade-out.

A user may wish to exactly go to a particular scene any time while viewing a video file and clip or edit moving pictures of the particular scene. However, it is difficult with conventional methods to exactly access a portion having a change in content.

Accordingly, a method of finding out a portion having a scene change in an entire sequence of frames and a method allowing random access to the portion are desired.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

The present invention provides a function of adaptively inserting a keyframe into a portion having a scene change, such as scene transition or fade-in, in video flow, thereby allowing random access during video playback.

The present invention also provides a method of detecting a portion having a scene change in video flow.

According to an aspect of the present invention, there is provided a video encoder comprising: a coding mode determination unit receiving a temporal residual frame with respect to an original frame, determining whether the original frame has a scene change by comparing the temporal residual frame with a predetermined reference, determining to encode the temporal residual frame when it is determined that the original frame does not have the scene change, and determining to encode the original frame when it is determined that the original frame has the scene change; and a spatial transformer performing spatial transform on either of the temporal residual frame and the original frame according to the determination of the coding mode determination unit and obtaining a transform coefficient.

The video encoder may further comprise a quantizer quantizing the transform coefficient.

Also, the video encoder may further comprise an entropy coder compressing the quantized transform coefficient and keyframe position information using a predetermined coding method, thereby generating a bitstream.

The coding mode determination unit may comprise: a block mode selector comparing cost for inter-estimation with cost for intra-estimation with respect to a macroblock and generating a multiple temporal residual frame using estimation needing less cost between the inter-estimation and the intra-estimation; and a block mode comparator computing a proportion of intra-estimated macroblocks in the multiple temporal residual frame and determining to encode the original frame when the computed proportion exceeds a predetermined threshold R_{c1}.

The coding mode determination unit may comprise: a motion estimator receiving the original frame and sequentially performing motion estimation between the original frame and a previous frame to obtain a motion vector; a temporal filter generating a motion compensation frame using the motion vector and computing a difference between the original frame and the motion compensation frame; and a mean absolute difference (MAD) comparator computing an average of the difference between the original frame and the motion compensation frame and comparing the average difference with a predetermined threshold R_{c2}.

According to another aspect of the present invention, there is provided a video decoder comprising: an entropy decoder analyzing an input bitstream and extracting texture information of an encoded frame, a motion vector, a reference frame number, and key frame position information from the encoded frame; a dequantizer dequantizing the texture information into transform coefficients; an inverse spatial transformer restoring a video sequence by performing inverse spatial transform on the transform coefficients when a current frame is determined as a keyframe based on the keyframe position information and generating a temporal residual frame by performing the inverse spatial transform on the transform coefficients when the current frame is not the keyframe; and an inverse temporal filter restoring a video sequence from the temporal residual frame using the motion vector.

According to still another aspect of the present invention, there is provided a video encoding method comprising: receiving a temporal residual frame with respect to an original frame, determining whether the original frame has a scene change by comparing the temporal residual frame with a predetermined reference, determining to encode the temporal residual frame when it is determined that the original frame does not have the scene change, and determining to encode the original frame when it is determined that the original frame has the scene change; and performing spatial transform on either of the temporal residual frame and the original frame according to a result of the determination performed in the receiving of a temporal residual frame and obtaining a transform coefficient.

The video encoding method may further comprise quantizing the transform coefficient.

Also, the video encoding method may further comprise compressing the quantized transform coefficient and key frame position information by a predetermined coding method.

The receiving of the temporal residual frame may comprises: comparing inter-estimation cost with intra-estimation cost for each macroblock, selecting estimation needing less cost, and generating a multiple temporal residual frame; and computing a proportion of intra-estimated macroblocks in the multiple temporal residual frame and, when the proportion exceeds a predetermined threshold R_{c1} determining that the original frame instead of the multiple temporal residual frame is used.

The inter-estimation cost may be a minimum cost among costs for one or more estimations that are used for a current frame among forward estimation, backward estimation, and bidirectional estimation.

Cost C_{fk} for the forward estimation may be a sum of E_{fk} and λB_{fk}, cost C_{bk} for the backward estimation is a sum of E_{bk} and λB_{bk}, and cost C₂ₖ for the bidirectional estimation is a sum of E₂ₖ and λ(B_{fk}+B_{bk}), where E_{fk}, E_{bk}, and E₂ₖ respectively indicate a sum of absolute differences (SAD) of a k-th macroblock in the forward estimation, an SAD of the k-th macroblock in the backward estimation, and an SAD of the k-th macroblock in the bidirectional estimation, B_{fk} indicates the number of bits allocated to quantize a motion vector of the k-th macroblock obtained through the forward estimation, B_{bk} indicates the number of bits allocated to quantize a motion vector of the k-th macroblock obtained through the backward estimation, and λ is a Lagrange coefficient which is used to control balance between the number of bits related with a motion vector and the number of texture bits.

The cost Cᵢₖ for the intra-estimation may be a sum of Eᵢₖ and λBᵢₖ, where Eᵢₖ indicates a sum of absolute differences (SAD) of a k-th macroblock in the intra-estimation, Bᵢₖ indicates the number of bits used to compress a DC component in the intra-estimation, and λ is a Lagrange coefficient which is used to control balance between the number of bits related with a motion vector and the number of texture bits.

The receiving of the temporal residual frame may comprise: receiving the original frame and sequentially performing motion estimation between the original frame and a previous frame to obtain a motion vector; generating a motion compensation frame using the motion vector and computing a difference between the original frame and the motion compensation frame; and computing an average of the difference between the original frame and the motion compensation frame and comparing the average difference with a predetermined threshold R_{c2}.

The threshold R_{c2} is preferably a value obtained by multiplying a predetermined constant (α) by an average of MADs that are accumulated with respect to a current video for a predetermined period of time.

In accordance with a further aspect of the present invention, there is provided a video decoding method comprising: analyzing an input bitstream and extracting texture information of an encoded frame, a motion vector, a reference frame number, and key frame position information from the encoded frame; dequantizing the texture information into transform coefficients; performing inverse spatial transform on the transform coefficients and restoring a final video sequence when a current frame is a keyframe based on the keyframe position information, or performing inverse spatial transform and generating a temporal residual frame when a current frame is not a keyframe; and restoring a final video sequence from the input temporal residual frame using the motion vector.

The key frame position information may be information for causing the original frame to be coded, when the current frame is considered as having a scene change, and informing a decoder that the encoded frame is a key frame transmitted to a decoder.

### BRIEF DESCRIPTION OF THE DRAWINGS

The above and other aspects of the present invention will become more apparent by describing in detail exemplary embodiments thereof with reference to the attached drawings in which:

FIG. 1 illustrates an example of a video sequence;

FIG. 2 illustrates an example of a video sequence having a scene change;

FIG. 3 is a block diagram of an encoder according to a first exemplary embodiment of the present invention;

FIG. 4A illustrates an example of a motion estimation direction when I-, P- and B-frames are used;

FIG. 4B illustrates an example of an estimation direction used by the encoder illustrated in FIG. 3;

FIG. 5 is a diagram illustrating four estimation modes;

FIG. 6 illustrates an example in which macroblocks in a single frame are coded using different methods in accordance with minimum cost;

FIG. 7A illustrates an example in which estimation is performed on a video sequence having a rapid change in a multiple mode;

FIG. 7B illustrates an example in which estimation is performed on a video sequence having little change in the multiple mode;

FIG. 8 is a block diagram of an encoder according to a second exemplary embodiment of the present invention;

FIG. 9 is a block diagram of a decoder according to an exemplary embodiment of the present invention; and

FIG. 10 is a schematic block diagram of a system in which an encoder and a decoder according to an exemplary embodiment of the present invention operate.

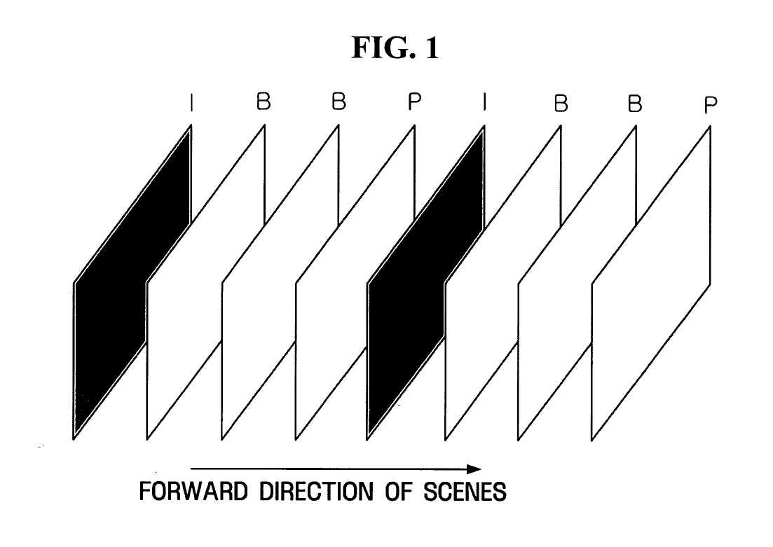

### DETAILED DESCRIPTION OF THE EXEMPLARY EMBODIMENTS OF THE INVENTION

The advantages, features of the present invention and methods for accomplishing the same will now be described more fully with reference to the accompanying drawings, in which exemplary embodiments of the invention are shown. This invention may, however, be embodied in many different forms and should not be construed as being limited to the exemplary embodiments set forth herein; rather, these exemplary embodiments are provided so that this disclosure will be thorough and complete, and will fully convey the concept of the invention to those skilled in the art. The invention is defined by the appended claims intended to cover all such modifications which may fall within the spirit and scope of the invention. Throughout the specification, the same reference numerals in different drawings represent the same element.

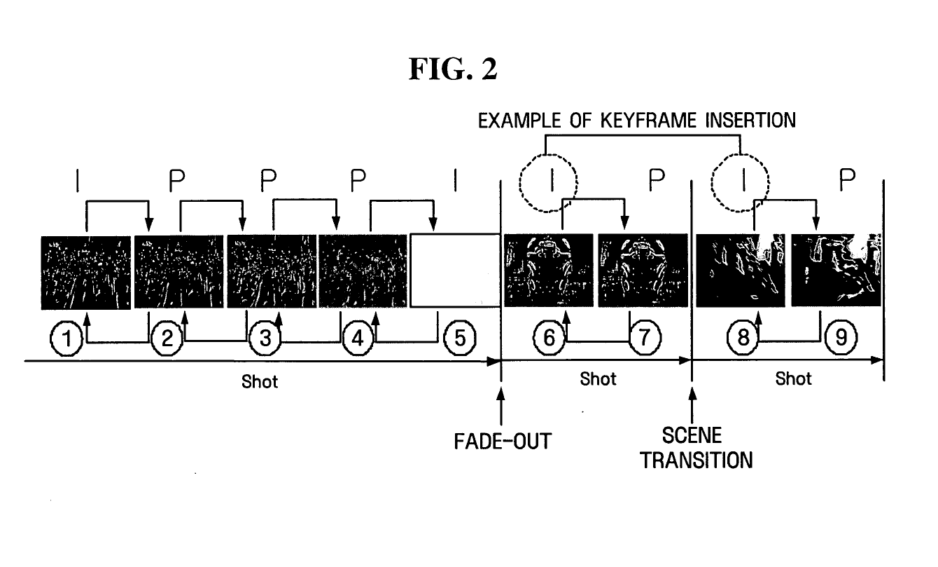

Referring to FIG. 2, fade-out occurs between a fifth frame and a sixth frame, and scene transition occurs between a seventh frame and an eight frame. Two images preceding and succeeding such scene change rarely have continuity and have a big difference. Accordingly, it is necessary to convert an image having the scene change into a keyframe in order to increase usability of random access. In exemplary embodiments of the present invention, keyframes are inserted at regular intervals, and an additional keyframe is inserted into a portion having a scene change.

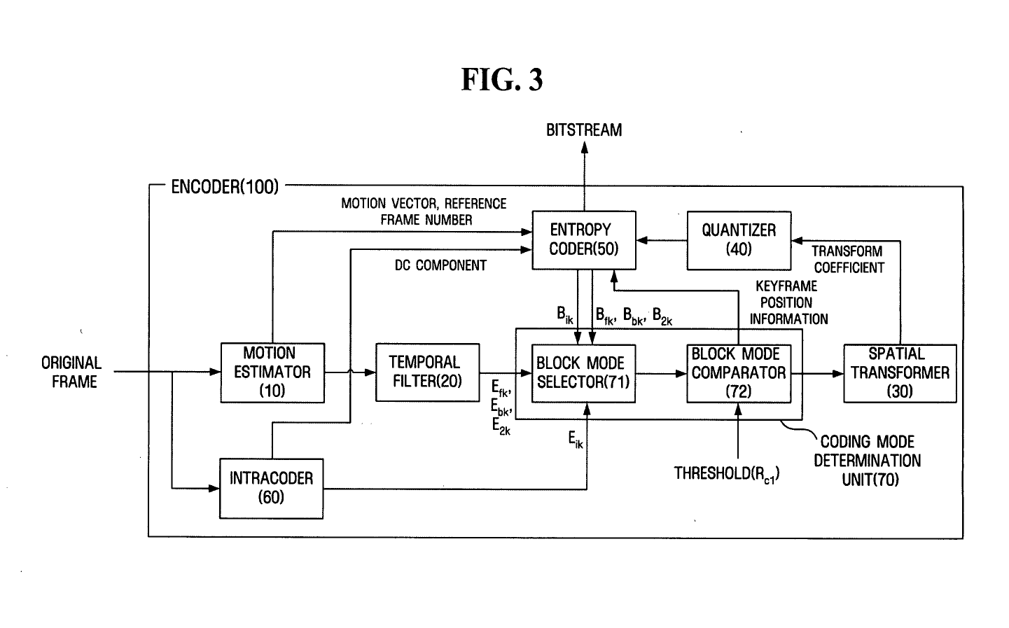

Referring to FIG. 3, an encoder 100 according to a first exemplary embodiment of the present invention includes a motion estimator 10, a temporal filter 20, a coding mode determination unit 70, a spatial transformer 30, a quantizer 40, an entropy coder 50, and an intracoder 60. The coding mode determination unit 70 includes a block mode selector 71 and a block mode comparator 72.

An original frame is input to the motion estimator 10 and the intracoder 60. The motion estimator 10 performs motion estimation on the input frame based on a predetermined reference frame and obtains a motion vector. A block matching algorithm is widely used for the motion estimation. In detail, a current macroblock is moved in units of pixels within a particular search area in the reference frame, and displacement giving a minimum error is estimated as a motion vector.

A method of determining the reference frame varies with encoding modes. The encoding modes may include a forward estimation mode where a temporally previous frame is referred to, a backward estimation mode where a temporally subsequent frame is referred to, and a bidirectional estimation mode where both of temporally previous and subsequent frames are referred to. As described above, a mode of estimating a motion of a current frame referring to another frame and performing temporal filtering is defined as an inter-estimation mode, while a mode of coding a current frame without referring to another frame is defined as an intra-estimation mode. In the inter-estimation mode, even after a forward, backward, or bidirectional mode is determined, a user can optionally selects a reference frame.

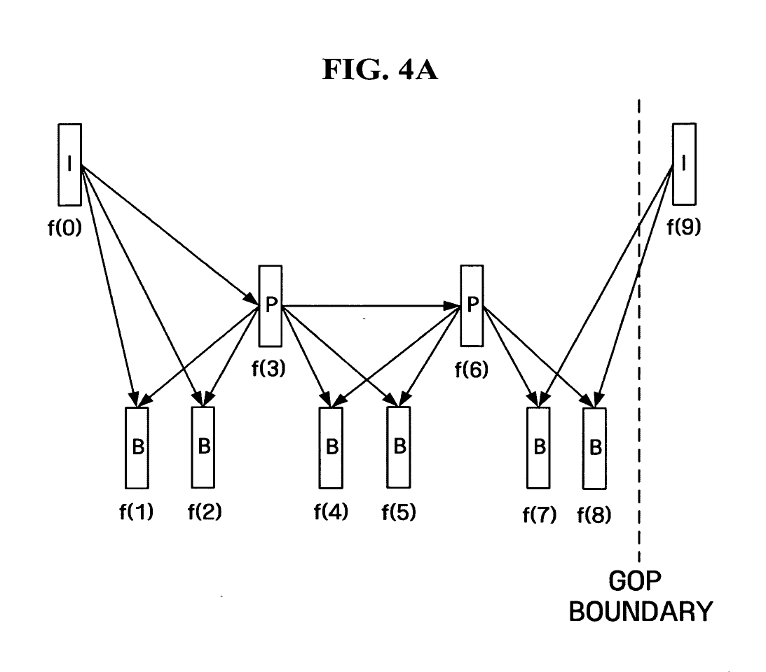

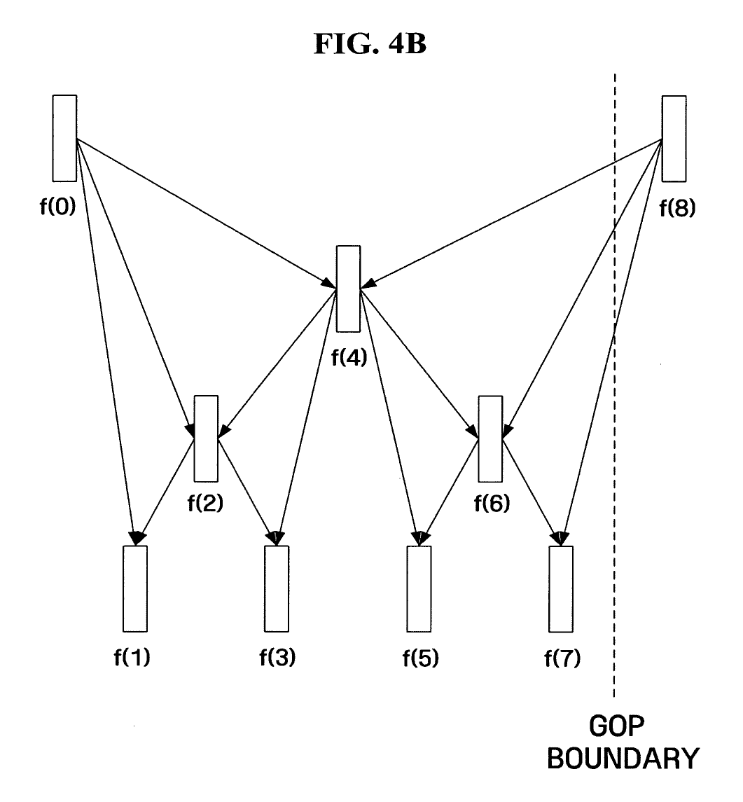

FIGS. 4A and 4B illustrate examples related with determination of a reference frame and a direction of motion estimation. In FIGS. 4A and 4B, f(0), f(1), . . . , f(9) denote frame numbers in a video sequence.

FIG. 4A illustrates an example of a motion estimation direction when I-frame, a P-frame, and a B-frame defined by a Moving Picture Experts Group (MPEG) are used. An I-frame is a keyframe that is encoded without referring to another frame. A P-frame is encoded using forward estimation, and a B-frame is encoded using bidirectional estimation.

Since a B-frame is encoded and decoded referring to a previous I- or P-frame and a subsequent I-frame or P-frame, an encoding or decoding sequence may be different from a temporal sequence, i.e., {0, 3, 1, 2, 6, 4, 5, 9, 7, 8 }.

FIG. 4B illustrates an example of bidirectional estimation used by the encoder 100 according to the first exemplary embodiment. Here, an encoding or decoding sequence may be {0, 4, 2, 1, 3, 8, 6, 5, 7}. As described above, in the first exemplary embodiment, it is assumed that bidirectional estimation is performed with respect to an interframe, and all forward, backward, and bidirectional estimations are performed on a macroblock for computation of cost described later.

When motion estimation is performed using a method illustrated in FIG. 4A, since a P-frame allows only forward estimation, inter-estimation on the P-frame includes only backward estimation. In other words, inter-estimation does not always include the forward, backward, and bidirectional estimations but may include only one or two of the three estimations according to a type of frame.

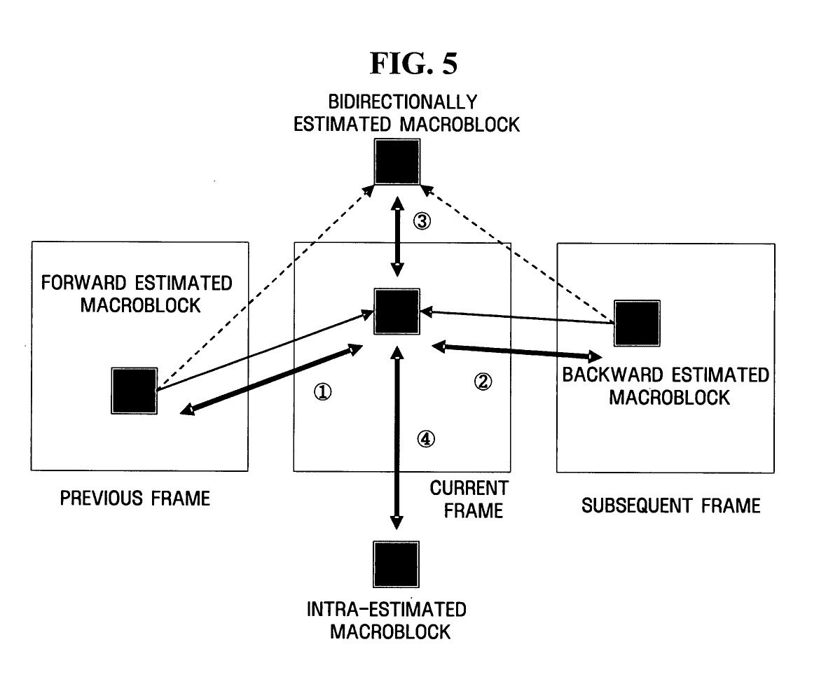

FIG. 5 is a diagram illustrating four estimation modes. In a forward estimation mode \mathring{1}, a macroblock that matches a particular macroblock in a current frame is found in a previous frame (that does not necessarily precede the current frame immediately), and displacement between positions of the two macroblocks is expressed in a motion vector.

In a backward estimation mode \mathring{2}, a macroblock that matches the particular macroblock in the current frame is found in a subsequent frame (that does not necessarily succeed the current frame immediately), and displacement between positions of the two macroblocks is expressed in a motion vector.

In a bidirectional estimation mode \mathring{3}, an average of the macroblock found in the forward estimation mode \mathring{1} and the macroblock found in the backward estimation mode \mathring{2} is obtained using or without using a weight to make a virtual macroblock, and a difference between the virtual macroblock and the particular macroblock in the current frame is computed and then temporally filtered. Accordingly, in the bidirectional estimation mode \mathring{3}, two motion vectors are needed per one macroblock in the current frame.

When a macroblock matching a current macroblock is found in each of the forward, backward, and bidirectional estimation modes, a macroblock region is moved in units of pixels within a predetermined search area. Whenever the macroblock region is moved, a sum of differences between pixels in the current macroblock and pixels in the macroblock region is computed. Thereafter, a macroblock region giving a minimum sum is selected as the macroblock matching the current macroblock.

The motion estimator 10 determines a motion vector for each of macroblocks in the input frame and transmits the motion vector and the frame number to the entropy coder 50 and the temporal filter 20. For motion estimation, hierarchical variable size block matching (HVSBM) may be used. However, in exemplary embodiments of the present invention, simple fixed block size motion estimation is used.

Meanwhile, the intracoder 60 receiving the original frame calculates a difference between each of original pixel values in a macroblock and a DC value of the macroblock using the intra-estimation mode \mathring{4}. In the intra-estimation mode \mathring{4}, estimation is performed on a macroblock included in a current frame based on a DC value (i.e., an average of pixel values in the macroblock) of each of Y, U, and V components. A difference of between each original pixel value and a DC value is encoded, and differences among the three DC values are encoded instead of a motion vector.

In some video sequences, scenes change very fast. In an extreme case, a frame that has no temporal redundancy compared to adjacent frames may be found. To handle such frame, a coding method implemented by MC-EZBC supports an “adaptive (group-of-pictures) GOP size feature”. According to the adaptive GOP size feature, when the number of disconnected pixels is greater than a predetermined reference value (i.e., about 30% of the total number of pixels), temporal filtering is stopped and a current frame is coded into an L-frame. Such method may be used in exemplary embodiments of the present invention. However, to use a more flexible method, a concept of a macroblock obtained through intra-estimation that is used in a standard hybrid encoder is employed. Generally, an open-loop codec cannot use adjacent macroblock information due to estimation drift. However, a hybrid codec can use an intra-estimation mode. Accordingly, in the first exemplary embodiment of the present invention, DC estimation is used for the intra-estimation mode. In the intra-estimation mode, some macroblocks may be estimated using DC values for their Y, U, and V components.

The intracoder 60 transmits a difference between an original pixel value and a DC value with respect to a macroblock to the coding mode determination unit 70 and transmits a DC component to the entropy coder 50. The difference an original pixel value and a DC value with respect to a macroblock can be represented by Eᵢₖ. Here, E denotes a difference between an original pixel value and a DC value, i.e., an error, and “i” denotes intra-estimation. When the total number of macroblocks is N, “k” is an index indicating a particular macroblock (k=0, 1, . . . , N-1). Consequently, Eᵢₖ indicates a sum of absolute differences (SAD) (i.e., Sum of differences between original luminance values and a DC value in intra-estimation of a k-th macroblock. An SAD is a sum of differences between corresponding pixel values within two corresponding macroblocks respectively included in two frames.

The temporal filter 20 rearranges a macroblock in the reference frame using the motion vector and the reference frame number received from the motion estimator 10 so that the macroblock in the reference frame occupies the same position as a matching macroblock in the current frame, thereby generating a motion compensation frame. In addition, the temporal filter 20 obtains a difference between the current frame and the motion compensation frame, i.e., a temporal residual frame.

As a result of temporal filtering, a difference is obtained with respect to each types of inter-estimation mode. According to a user's selection, the inter-estimation mode may include at least one mode among a forward estimation mode, a backward estimation mode, and a bidirectional estimation mode. In the first exemplary embodiment of the present invention, it is assumed that the inter-estimation mode includes all of the three modes.

Differences are obtained with respect to each macroblock in the current frame in the three inter-estimation modes and transmitted to the coding mode determination unit 70. Three differences are represented with E_{fk}, E_{bk}, and E₂ₖ. Here, E denotes a difference, i.e., an error between frames, “f” denotes a forward direction, “b” denotes a backward direction, and “2” denotes a bidirection. When the total number of macroblocks in the current frame is N, “k” denotes an index indicating a particular macroblock (k=0, 1, . . . , N-1).

Consequently, E_{fk} indicates an SAD of the k-th macroblock in the forward estimation mode, E_{bk} indicates an SAD of the k-th macroblock in the backward estimation mode, and E₂ₖ indicates an SAD of the k-th macroblock in the bidirectional estimation mode.

The entropy coder 50 compresses the motion vector received from the motion estimator 10 and the DC component received from the intracoder 60 using a predetermined coding method, thereby generating a bitstream. Examples of the predetermined coding method include a predictive coding method, a variable-length coding method (typically Huffmann coding), and an arithmetic coding method.

After generating the bitstream, the entropy coder 50 transmits the numbers of bits respectively used to compress the motion vector of the current macroblock according to the three inter-estimation modes to the coding method determination unit 70. The numbers of bits used in the three inter-estimation modes may be represented with B_{fk}, B_{bk}, and B₂ₖ, respectively. Here, B denotes the number of bits used to compress the motion vector, “f” denotes a forward direction, “b” denotes a backward direction, and “2” denotes a bidirection. When the total number of macroblocks in the current frame is N, “k” denotes an index indicating a particular macroblock (k=0, 1, . . . , N-1).

In other words, B_{fk} indicates the number of bits allocated to quantize a motion vector of the k-th macroblock obtained through forward estimation, B_{bk} indicates the number of bits allocated to quantize a motion vector of the k-th macroblock obtained through backward estimation, and B₂ₖ indicates the number of bits allocated to quantize a motion vector of the k-th macroblock obtained through bidirectional estimation.

After generating the bitstream, the entropy coder 50 also transmits the number of bits used to compress the DC component of the current macroblock to the coding mode determination unit 70. The number of bits may be represented with Bᵢₖ. Here, B denotes the number of bits used to compress the DC component, and “i” denotes an intra-estimation mode. When the total number of macroblocks in the current frame is N, “k” denotes an index indicating a particular macroblock (k=0, 1, . . . , N-1).

The block mode selector 71 in the coding mode determination unit 70 compares inter-estimation cost with intra-estimation cost for each macroblock, selects estimation needing less cost, and generates a multiple temporal residual frame. The block mode comparator 72 computes a proportion of intra-estimated macroblocks in the multiple temporal residual frame and, when the proportion exceeds a predetermined threshold R_{c1}, determines that the original frame instead of the multiple temporal residual frame is used. The multiple temporal residual frame will be described in detail later.

The block mode selector 71 receives the differences E_{fk}, E_{bk}, and E₂ₖ obtained with respect to each macroblock in the inter-estimation modes from the temporal filter 20 and receives the difference Eᵢₖ obtained with respect to each macroblock in the intra-estimation mode from the intracoder 60. In addition, the block mode selector 71 receives the numbers of bits B_{fk}, B_{bk}, and B₂ₖ used to compress motion vectors obtained with respect to each macroblock in the inter-estimation modes, respectively, and the number of bits Bᵢₖ used to compress the DC component in the intra-estimation mode from the entropy coder 50.

The inter-estimation costs can be expressed by Equations (1). In Equations (1), C_{fk}, C_{bk}, and C₂ₖ denote costs required for each macroblock in the forward, backward, and bidirectional estimation modes, respectively. Since B₂ₖ is the number of bits used to compress a motion vector obtained through bidirectional estimation, it is a sum of bits for forward estimation and bits for backward estimation, i.e., a sum of B_{fk} and B_{bk}.
C_{fk}=E_{fk}+λB_{fk}
C_{bk}=E_{bk}+λB_{bk} (1)
C₂ₖ=E₂ₖ+λB₂ₖ, here B₂ₖ=B_{fk}+B_{bk}

Here, λ is a Lagrange coefficient which is used to control balance between the number of bits related with a motion vector and the number of texture (i.e., image) bits. Since a final bit rate is not known in a scalable video encoder, λ may be selected according to characteristics of a video sequence and a bit rate that are mainly used in a target application. An optimal inter-estimation mode can be determined for each macroblock based on minimum cost obtained using Equations (1).

When the intra-estimation cost is smaller than cost for the optimal inter-estimation mode, the intra-estimation mode is selected. In this case, differences between original pixels and a DC value are coded, and differences among three DC values instead of a motion vector are coded. The intra-estimation cost can be expressed by Equation (2), in which Cᵢₖ denotes cost for intra-estimation of each macroblock.
Cᵢₖ=Eᵢₖ+λBᵢₖ (2)

If Cᵢₖ is less than minimum inter-estimation cost, for example, a minimum value among C_{fk}, C_{bk}, and C₂ₖ, coding is performed in the intra-estimation mode.

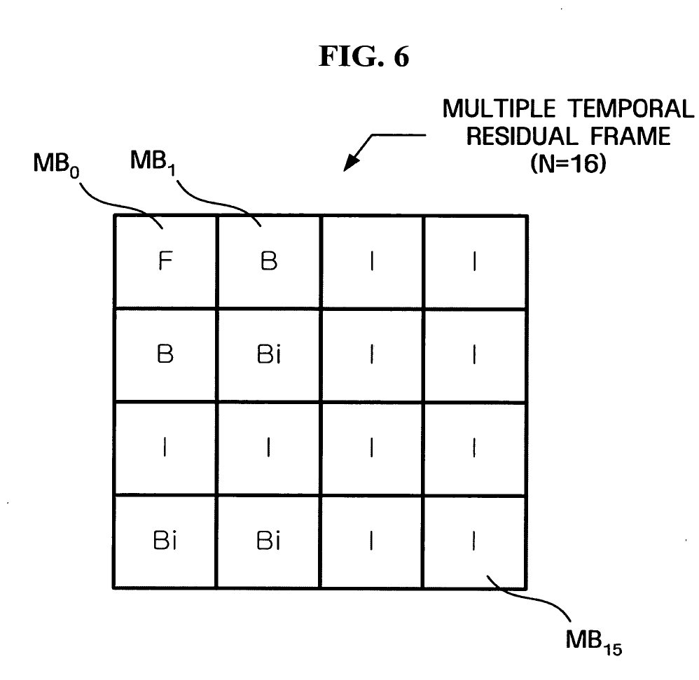

FIG. 6 illustrates an example in which macroblocks in a single frame are coded using different methods in accordance with the minimum cost. The frame includes N=16 macroblocks, and MB denotes a macroblock. F, B, Bi, and I indicate that corresponding macroblocks have been coded in the forward estimation mode, the backward estimation mode, the bidirectional estimation mode, and the intra-estimation mode, respectively.

Such mode in which different coding modes are used for individual macroblocks is defined as a “multiple mode”, and a temporal residual frame reconstructed in the multiple mode is defined as a “multiple temporal residual frame”.

Referring to FIG. 6, a macroblock MB₀ has been coded in the forward estimation mode since C_{bk} was selected as a minimum value as a result of comparing C_{fk}, C_{bk}, and C₂ₖ with one another and was determined as being less than Cᵢₖ. A macroblock MB₁₅ has been coded in the intra-estimation mode since intra-estimation cost was less than inter-estimation cost.

The block mode comparator 72 computes a proportion of macroblocks that have been coded in the intra-estimation mode in the multiple temporal residual frame obtained by performing temporal filtering on the individual macroblocks in estimation modes determined for the respective macroblocks by the block mode selector 71. If the proportion does not exceed the predetermined threshold R_{c1}, the block mode comparator 72 transmits the multiple temporal residual frame to the spatial transformer 30. If the proportion exceeds the predetermined threshold R_{c1}, the block mode comparator 72 transmits the original frame instead of the coded frame to the spatial transformer 30.

As described above, when the proportion of macroblocks coded in the intra-estimation mode exceeds a predetermined threshold, a current frame is considered as having a scene change. A position of the frame considered as having the scene change is determined a frame position (hereinafter, referred to as a “key frame position”) where an additional keyframe besides regularly inserted keyframes is inserted.

In the first exemplary embodiment of the present invention, the original frame is transmitted to the spatial transformer 30. However, the original frame may be entirely coded in the intra-estimation mode, and then the coded frame may be transmitted to the spatial transformer 30. Since Eᵢₖ computed for each macroblock has been stored in a buffer (not shown), the entire frame can be coded in the intra-estimation mode without additional operations.

As shown in FIG. 6, a current frame may be coded in different modes by the block mode selector 71, and the block mode comparator 72 can detect a proportion of each coding mode. Referring to FIG. 6, proportions are F= 1/16=6.25%, B= 2/16=12.5%, Bi= 3/16=18.75%, and I= 10/16=62.5%. Here, Bi, F, B, and I denote proportions of macroblocks that have been coded in the bidirectional estimation mode, the forward estimation mode, the backward estimation mode, and the intra-estimation mode, respectively. However, estimation is not performed on a first frame in a GOP.

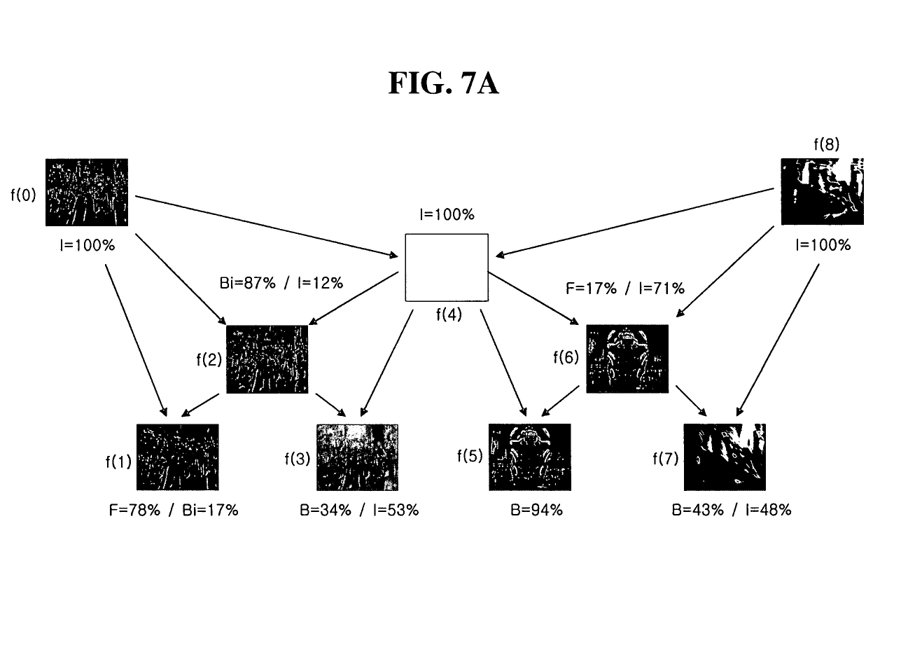

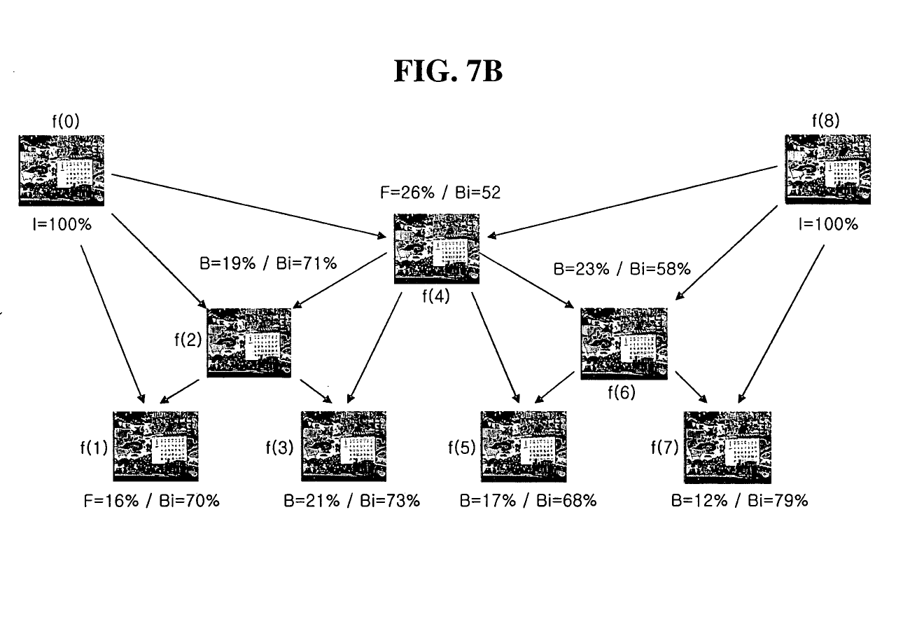

FIGS. 7A and 7B respectively illustrate an example in which estimation is performed on a video sequence having a rapid change in a multiple mode and an example in which estimation is performed on a video sequence having little change in the multiple mode. A percentage denotes a proportion of an estimation mode.

Referring to FIG. 7A, since a frame f(1) is almost the same as a frame f(0), “F” is a dominant proportion of 78%. Since a frame f(2) approximates to a medium between the frame f(0) and a frame f(4) , that is, the frame f(2) corresponds to an image obtainable by making the frame f(0) brighter, “Bi” is a dominant proportion of 87%. Since a frame f(4) is totally different from the other frames, “I” is 100%. Since a frame f(5) is totally different from the frame f(4) and is similar to a frame f(6), “B” is 94%.

Referring to FIG. 7B, all frames are similar. Actually, when all frames are similar, bidirectional estimation shows best performance. Accordingly, in FIG. 7B, Bi is high as a whole.

When a current frame includes more macroblocks coded in the inter-estimation mode than macroblocks coded in the intra-estimation, temporal compensation is efficient due to high similarity between adjacent images, and it can be inferred that consecutive scenes are connected. However, when the current frame includes more macroblocks coded in the intra-estimation mode than macroblocks coded in the inter-estimation, it can be inferred that temporal compensation between adjacent images is not efficient or that a great scene change occurs between frames.

Accordingly, in the first exemplary embodiment of the present invention, when the proportion “I” exceeds the predetermined threshold R_{cl}, an original frame or a frame coded only in the intra-estimation mode is used instead of a frame coded in different estimation modes for individual macroblocks.

Referring back to FIG. 3, the spatial transformer 30 reads from a buffer (not shown) the frame coded in different estimation modes for individual macroblocks or the original frame considering cost according to the determination of the coding mode determination unit 70. Then, the spatial transformer 30 performs spatial transform on the frame read from the buffer to remove spatial redundancy and generates a transform coefficient.

Wavelet transform supporting scalability or discrete cosine transform (DCT) widely used in video compression such as MPEG-2 may be used as the spatial transform. The transform coefficient may be a wavelet coefficient in the wavelet transform or a DCT coefficient in the DCT.

The quantizer 40 quantizes the transform coefficient generated by the spatial transformer 30. In other words, the quantizer 40 converts the transform coefficient from a real number into an integer. Through the quantization, the number of bits needed to express image data can be reduced. Typically, an embedded quantization technique is used in quantizing the transform coefficient. Examples of the embedded quantization technique include an embedded zerothrees wavelet (EZW) algorithm, a set partitioning in hierarchical trees (SPIHT), and the like.

The entropy coder 50 receives the quantized transform coefficient from the quantizer 40 and compresses it using a predetermined coding method, thereby generating a bitstream. In addition, the entropy coder 50 compresses the motion vector received from the motion estimator 10 and the DC component received from the intracoder 60 into the bitstream. Since the motion vector and the DC component have been compressed into a bitstream and their information has been transmitted to the coding mode determination unit 70, the bitstream into which the motion vector and the DC component have been compressed may be stored in a buffer (not shown) and used when necessary.

Also, the entropy coder 50 compresses the reference frame number received from the motion estimator 10 and keyframe position information received from the block mode comparator 72 using a predetermined coding method, thereby generating a bitstream. The keyframe position information may be transmitted by writing a keyframe number into a sequence header of an independent video entity or a GOP header of a GOP or by writing whether a current frame is a keyframe into a frame header of the current frame.

Examples of the predetermined coding method include a predictive coding method, a variable-length coding method (typically Huffmann coding), and an arithmetic coding method.

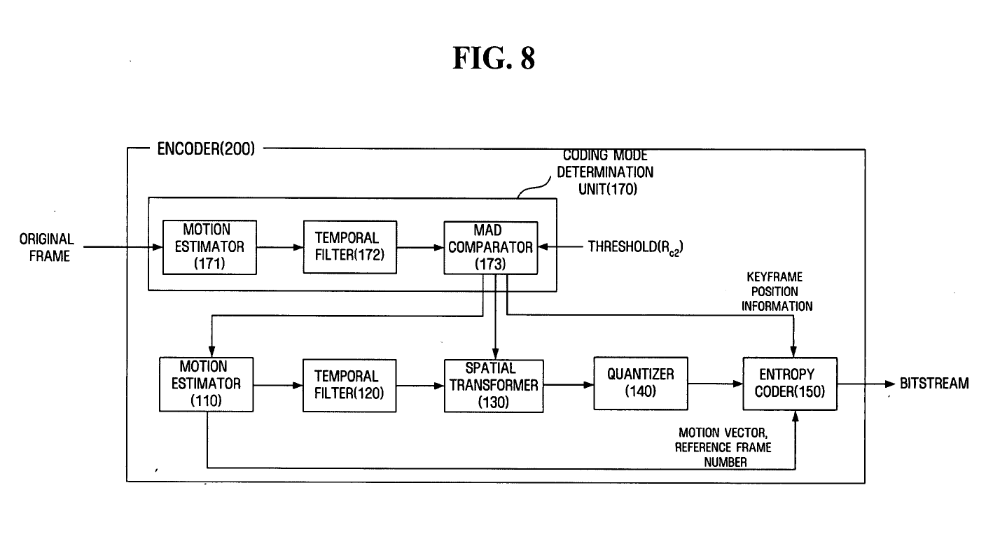

FIG. 8 is a block diagram of an encoder 200 according to a second exemplary embodiment of the present invention. The encoder 200 includes a motion estimator 110, a temporal filter 120, a coding mode determination unit 170, a spatial transformer 130, a quantizer 140, and an entropy coder 150. The coding mode determination unit 170 may include a motion estimator 171, a temporal filter 172, and a mean absolute difference (MAD) comparator 173.

In the first exemplary embodiment, occurrence of a scene change is determined based on a proportion of macroblocks coded in the intra-estimation mode in a current frame. However, in the second exemplary embodiment of the present invention, a MAD between adjacent frames is computed, and when the MAD exceeds a predetermined threshold R_{c2}, it is determined that the scene change has been occurred. A MAD is obtained by computing a sum of differences in pixel values between corresponding pixels occupying the same spatial position in two frames and then dividing the sum by the total number of pixels included in each frame.

For this operation, the motion estimator 171 included in the coding mode determination unit 170 receives an original frame, i.e., a current frame, and performs motion estimation to obtain a motion vector. Here, forward estimation is sequentially performed in a time domain. For example, a first frame is used as a reference frame for a second frame, and the second frame is used as a reference frame for a third frame.

The temporal filter 172 included in the coding mode determination unit 170 reconstructs the reference frame using the motion vector received from the motion estimator 171 such that a macroblock in the reference frame occupies the same position as a matching macroblock in the current frame, thereby generating a motion compensation frame, and computes a difference between the current frame and the motion compensation frame.

The MAD comparator 173 included in the coding mode determination unit 170 computes an average of the difference, i.e., an average of differences in pixel values, between the current frame and the motion compensation frame and compares the average difference with the predetermined threshold R_{c2}. The threshold R_{c2} may be optionally set by a user but may be set to a value obtained by multiplying a constant (α) by an average of MADs that are accumulated for a certain period of time. For example, the threshold R_{c2} may be set to a value obtained by multiplying 2 by an average of MADs accumulated for the period of time.

When an MAD of the current frame exceeds the predetermined threshold, it is considered that a scene change has occurred, and a frame position where an additional keyframe besides periodically inserted keyframes is inserted is determined. When the frame position where the additional keyframe is inserted is determined, the original frame is encoded.

When it is determined that the current frame corresponds to a keyframe position as a result of comparison by the MAD comparator 173, spatial transform is performed in the spatial transformer 130. However, when the current frame does not correspond to the keyframe position, motion estimation is performed in the motion estimator 110.

The motion estimator 110 receives the original frame and performs motion estimation to obtain a motion vector. Differently from the motion estimator 171 included in the coding mode determination unit 170, the motion estimator 110 may use any one among forward estimation, backward estimation, and bidirectional estimation. A reference frame is not restricted to a frame immediately preceding a current frame but may be selected from among frames separated from the current frame by random intervals.

The temporal filter 120 reconstructs the reference frame using the motion vector received from the motion estimator 110 such that a macroblock in the reference frame occupies the same position as a matching macroblock in the current frame, thereby generating a motion compensation frame, and computes a difference between the current frame and the motion compensation frame.

The spatial transformer 130 receives information on whether the current frame corresponds to the keyframe position from the MAD comparator 173 and performs spatial transform on the difference between the current frame and the motion compensation frame that is computed by the temporal filter 120 or on the original frame. The spatial transform may be wavelet transform or DCT.

The quantizer 140 quantizes a transform coefficient generated by the spatial transformer 130.

The entropy coder 150 compresses the quantized transform coefficient, the motion vector and a reference frame number received from the motion estimator 110, and the key frame position information received from the MAD comparator 173 using a predetermined coding method, thereby generating a bitstream.

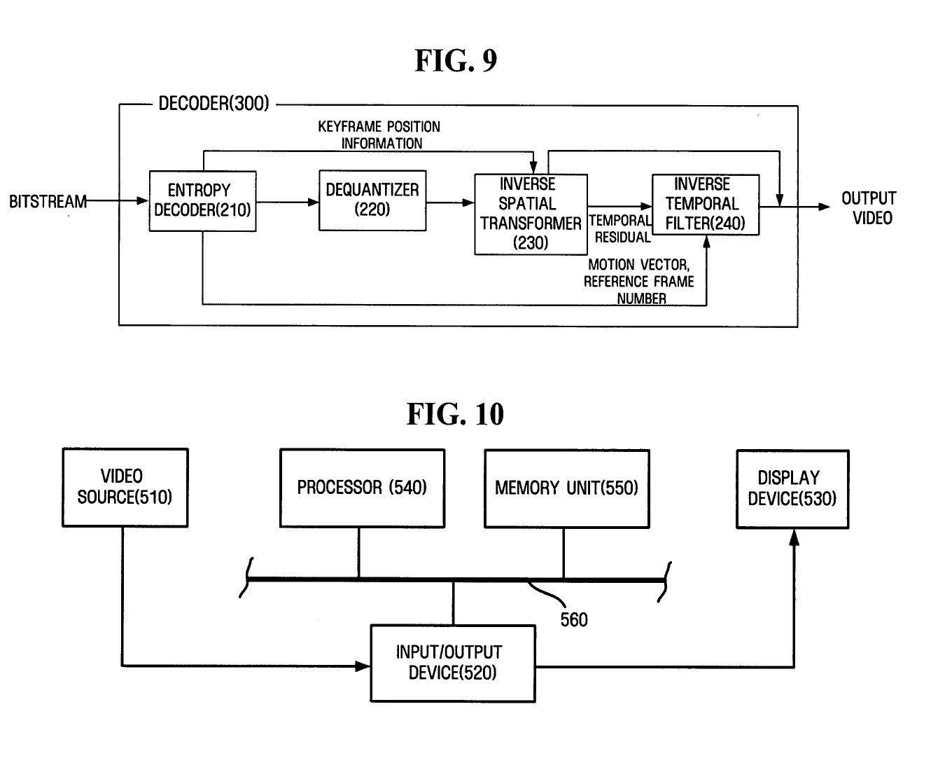

FIG. 9 is a block diagram of a decoder 300 according to an exemplary embodiment of the present invention. An entropy decoder 210 analyzes an input bitstream and extracts texture information of an encoded frame (i.e., encoded image information), a motion vector, a reference frame number, and key frame position information from the encoded frame. In addition, the entropy decoder 210 transmits the keyframe position information to an inverse spatial transformer 230. Entropy decoding is performed in a reverse manner to entropy coding performed in an encoder.

A dequantizer 220 dequantizes the texture information into transform coefficients. Dequantization is performed in a reverse manner to quantization performed in the encoder.

The inverse spatial converter 230 performs inverse spatial transform on the transform coefficients. Inverse spatial transform is related with spatial transform performed in the encoder. When wavelet transform has been used for the spatial transform, inverse wavelet transform is performed. When DCT has been used for the spatial transform, inverse DCT is performed.

The inverse spatial converter 230 can detect using the keyframe position information received from the entropy decoder 210 whether a current frame is a keyframe, that is, whether the current frame is an intraframe obtained through coding in the intra-estimation mode or an interframe obtained through coding in the inter-estimation mode. When the current frame is the intraframe, a video sequence is finally restored through the inverse spatial transform. When the current frame is the interframe, a frame comprised of temporal differences, i.e., a temporal residual frame is generated through the inverse spatial transform and is transmitted to an inverse temporal filter 240.

The inverse temporal filter 240 restores a video sequence from the temporal residual frame using the motion vector and the reference frame number that are received from the entropy decoder 210.

FIG. 10 is a schematic block diagram of a system 500 in which the encoder 100 or 200 and the decoder 300 according to an exemplary embodiment of the present invention operate. The system 500 may be a television (TV), a set-top box, a desktop, laptop, or palmtop computer, a personal digital assistant (PDA), or a video or image storing apparatus (e.g., a video cassette recorder (VCR) or a digital video recorder (DVR)). In addition, the system 500 may be a combination of the above-mentioned apparatuses or one of the apparatuses which includes a part of another apparatus among them. The system 500 includes at least one video/image source 510, at least one input/output unit 520, a processor 540, a memory 550, and a display unit 530.

The video/image source 510 may be a TV receiver, a VCR, or other video/image storing apparatus. The video/image source 510 may indicate at least one network connection for receiving a video or an image from a server using Internet, a wide area network (WAN), a local area network (LAN), a terrestrial broadcast system, a cable network, a satellite communication network, a wireless network, a telephone network, or the like. In addition, the video/image source 510 may be a combination of the networks or one network including a part of another network among the networks.

The input/output unit 520, the processor 540, and the memory 550 communicate with one another through a communication medium 560. The communication medium 560 may be a communication bus, a communication network, or at least one internal connection circuit. Input video/image data received from the video/image source 510 can be processed by the processor 540 using to at least one software program stored in the memory 550 and can be executed by the processor 540 to generate an output video/image provided to the display unit 530.

In particular, the software program stored in the memory 550 includes a scalable wavelet-based codec performing a method of the present invention. The codec may be stored in the memory 550, may be read from a storage medium such as a compact disc-read only memory (CD-ROM) or a floppy disc, or may be downloaded from a predetermined server through a variety of networks.

Although exemplary embodiments of the present invention have been shown and described with reference to the attached drawings, it will be understood by those skilled in the art that changes may be made to these elements without departing from the features and spirit of the invention. Therefore, it is to be understood that the above-described exemplary embodiments have been provided only in a descriptive sense and will not be construed as placing any limitation on the scope of the invention.

According to the present invention, compared to conventional keyframe insertion based on temporal flow, a keyframe is inserted according to access to a scene based on the content of an image, so that usability of a function allowing access to a random image frame is increased.

In addition, since a frame corresponding to a scene change such as scene transition, fade-in, or fade-out is converted into a keyframe, a clearer image can be obtained at a video portion having the scene change.

Moreover, according to the present invention, a keyframe is inserted when a large change occurs between adjacent images so that the images can be efficiently restored.

1. A video encoder comprising:
a coding mode determination unit which receives a temporal residual frame with respect to an original frame, determines whether the original frame has a scene change by comparing the temporal residual frame with a predetermined reference, determines the temporal residual frame is to be encoded if it is determined that the original frame does not have the scene change, and determines the original frame is to be encode if it is determined that the original frame has the scene change; and
a spatial transformer which performs spatial transform on the temporal residual frame or the original frame according to a determination of the coding mode determination unit and generates a transform coefficient.

2. The video encoder of claim 1, further comprising a quantizer which quantizes the transform coefficient.

3. The video encoder of claim 2, further comprising an entropy coder which compresses the quantized transform coefficient and keyframe position information using a predetermined coding method to thereby generate a bitstream.

4. The video encoder of claim 1, wherein the coding mode determination unit comprises:
a block mode selector which compares a cost for an inter-estimation with a cost for an intra-estimation with respect to a macroblock and generates a multiple temporal residual frame using estimation needing less cost between the inter-estimation and the intra-estimation; and
a block mode comparator which computes a proportion of intra-estimated macroblocks in multiple temporal residual frames and determines to encode the original frame if the proportion exceeds a predetermined threshold R_{c1}.

5. The video encoder of claim 4, wherein the cost for the inter-estimation is a minimum cost among costs for at least one estimation that is used for a current frame among a forward estimation, a backward estimation, and a bidirectional estimation.

6. The video encoder of claim 5, wherein a cost C_{fk} for the forward estimation is a sum of E_{fk} and λB_{fk}, a cost C_{bk} for the backward estimation is a sum of E_{bk} and λB_{bk}, and a cost C₂ₖ for the bidirectional estimation is a sum of E₂ₖ and λ(B_{fk}+B_{bk}),
where E_{fk} is a sum of absolute differences (SAD) of a k-th macroblock in the forward estimation, E_{bk} is an SAD of the k-th macroblock in the backward estimation, and E₂ₖ is an SAD of the k-th macroblock in the bidirectional estimation,
B_{fk} is a number of bits allocated to quantize a motion vector of the k-th macroblock obtained through the forward estimation,
B_{bk} is a number of bits allocated to quantize a motion vector of the k-th macroblock obtained through the backward estimation, and
λ is a Lagrange coefficient which is used to control balance between a number of bits related with a motion vector and a number of texture bits.

7. The video encoder of claim 4, wherein the cost Cᵢₖ for the intra-estimation is a sum of Eᵢₖ and λ Bᵢₖ,
where Eᵢₖ is a sum of absolute differences (SAD) of a k-th macroblock in the intra-estimation,
Bᵢₖ is the number of bits used to compress a DC component in the intra-estimation, and
λ is a Lagrange coefficient which is used to control balance between a number of bits related with a motion vector and a number of texture bits.

8. The video encoder of claim 1, wherein the coding mode determination unit comprises:
a motion estimator which receives the original frame and sequentially performs motion estimation between the original frame and a previous frame to generate a motion vector;
a temporal filter which generates a motion compensation frame using the motion vector and computes a difference between the original frame and the motion compensation frame; and
a mean absolute difference (MAD) comparator which computes an average of the difference between the original frame and the motion compensation frame and compares the average difference with a predetermined threshold R_{c2}.

9. The video encoder of claim 8, wherein the predetermined threshold R_{c2} is a value obtained by multiplying a predetermined constant α by an average of MADs that are accumulated with respect to a current video for a predetermined time period.

10. A video decoder comprising:
an entropy decoder which analyzes an input bitstream and extracts texture information of an encoded frame, a motion vector, a reference frame number, and key frame position information from the encoded frame;
a dequantizer which dequantizes the texture information into transform coefficients;
an inverse spatial transformer which restores a video sequence by performing inverse spatial transform on the transform coefficients if a current frame is determined as a keyframe based on the keyframe position information and generates a temporal residual frame by performing the inverse spatial transform on the transform coefficients if the current frame is not the keyframe; and
an inverse temporal filter which restores a video sequence from the temporal residual frame using the motion vector.

11. The video decoder of claim 10, wherein the key frame position information comprises information for causing the original frame to be coded, when the current frame is considered as having a scene change, and informing a decoder that the encoded frame is a key frame transmitted to a decoder.

12. A video encoding method comprising:
receiving a temporal residual frame with respect to an original frame;
determining whether to encode the temporal residual frame or the original frame by determining whether the original frame has a scene change based on a comparison the temporal residual frame with a predetermined reference, wherein it is determined that the temporal residual frame is to be encoded if it is determined that the original frame does not have the scene change, and it is determined that the original frame is to be encoded if it is determined that the original frame has the scene change; and
performing spatial transform on the temporal residual frame or the original frame according to a result of the determining whether to encode the temporal residual frame or the original frame, and generating a transform coefficient.

13. The video encoding method of claim 12, further comprising quantizing the transform coefficient.

14. The video encoding method of claim 13, further comprising compressing the quantized transform coefficient and key frame position information by a predetermined coding method.

15. The video encoding method of claim 12, wherein the determining whether to encode the temporal residual frame or the original frame comprises:
comparing an inter-estimation cost with an intra-estimation cost for each macroblock;
selecting estimation needing less cost;
generating a multiple temporal residual frame;
computing a proportion of intra-estimated macroblocks in the multiple temporal residual frame; and
if the proportion exceeds a predetermined threshold R_{c1}, determining that the original frame instead of the multiple temporal residual frame is used.

16. The video encoding method of claim 15, wherein the inter-estimation cost is a minimum cost among costs for at least one estimation that is used for a current frame among a forward estimation, a backward estimation, and a bidirectional estimation.

17. The video encoding method of claim 16, wherein a cost C_{fk} for the forward estimation is a sum of E_{fk} and λB_{fk}, a cost C_{bk} for the backward estimation is a sum of E_{bk} and λB_{bk}, and a cost C₂ₖ for the bidirectional estimation is a sum of E₂ₖ and λ(B_{fk}+B_{bk}),
where E_{fk} is a sum of absolute differences (SAD) of a k-th macroblock in the forward estimation, E_{bk} is an SAD of the k-th macroblock in the backward estimation, and E₂ₖ is an SAD of the k-th macroblock in the bidirectional estimation,
B_{fk} is a number of bits allocated to quantize a motion vector of the k-th macroblock obtained through the forward estimation,
B_{bk} is a number of bits allocated to quantize a motion vector of the k-th macroblock obtained through the backward estimation, and
λ is a Lagrange coefficient which is used to control balance between a number of bits related with a motion vector and a number of texture bits.

18. The video encoding method of claim 15, wherein the cost Cᵢₖ for the intra-estimation is a sum of Eᵢₖ and λBᵢₖ,
where Eᵢₖ is a sum of absolute differences (SAD) of a k-th macroblock in the intra-estimation,
Bᵢₖ is a number of bits used to compress a DC component in the intra-estimation, and
λ is a Lagrange coefficient which is used to control balance between a number of bits related with a motion vector and a number of texture bits.

19. The video encoding method of claim 12, wherein the determining whether to encode the temporal residual frame or the original frame comprises:
receiving the original frame and sequentially performing motion estimation between the original frame and a previous frame to obtain a motion vector;
generating a motion compensation frame using the motion vector and computing a difference between the original frame and the motion compensation frame; and
computing an average of the difference between the original frame and the motion compensation frame and comparing the average difference with a predetermined threshold R_{c2}.

20. The video encoding method of claim 19, wherein the threshold R_{c2} is a value obtained by multiplying a predetermined constant α by an average of MADs that are accumulated with respect to a current video for a predetermined time period.

21. A video decoding method comprising:
analyzing an input bitstream and extracting texture information of an encoded frame, a motion vector, a reference frame number, and key frame position information from the encoded frame;
dequantizing the texture information into transform coefficients;
performing inverse spatial transform on the transform coefficients and restoring a final video sequence if a current frame is a keyframe based on the keyframe position information, or performing inverse spatial transform and generating a temporal residual frame if a current frame is not a keyframe; and
restoring a final video sequence from the input temporal residual frame using the motion vector.

22. The video decoding method of claim 21, wherein the key frame position information is information for causing the original frame to be coded, if the current frame is considered as having a scene change, and informing a decoder that the encoded frame is a key frame transmitted to a decoder.

23. A recording medium having a computer readable program recorded thereon, the program causing a computer to execute a video encoding method comprising:
receiving a temporal residual frame with respect to an original frame;
determining whether to encode the temporal residual frame or the original frame by determining whether the original frame has a scene change based on a comparison the temporal residual frame with a predetermined reference, wherein it is determined that the temporal residual frame is to be encoded if it is determined that the original frame does not have the scene change, and it is determined that the original frame is to be encoded if it is determined that the original frame has the scene change; and
performing spatial transform on the temporal residual frame or the original frame according to a result of the determining whether to encode the temporal residual frame or the original frame, and generating a transform coefficient.
